(19) United States
(12) Patent Application Publication
(10) Pub. No.: US 2002/0035645 A1
(43) Pub. Date: Mar. 21, 2002

(54) Application Architecture

(76) Inventor: Jeffrey T. Tuatini, San Francisco, CA (US)

Correspondence Address: PERKINS COIE LLP, PATENT-SEA, P.O. BOX 1247, SEATTLE, WA, 98111-1247, US

(21) Appl. No.: 09/753,037

(22) Filed: Dec. 28, 2000

Related U.S. Application Data
(60) Provisional application No. 60/173,712, filed on Dec. 30, 1999.

(51) Int. Cl. G06F 9/00; G06F 9/54; G06F 15/163

(52) U.S. Cl. 709/310

(57) ABSTRACT

An application architecture for developing applications for a computer system is provided. In one embodiment, the application architecture includes an application framework and applications. An application includes action handlers and view handlers. The action handlers implement the business logic of the application, and the view handlers control the formatting of the results returned by the business logic. The application framework receives requests for services from client computers (e.g., customer computers), identifies the action handlers that can service the requests, invokes the identified action handlers to service the requests to generate responses, identifies view handlers for formatting the responses, and invokes identified view handlers to format the responses and to send the responses to the client computers.

### CROSS-REFERENCE TO RELATED APPLICATIONS

This application claims the benefit of U.S. Provisional Patent Application No. 60/173,712, entitled “OMNIBUS,” filed on Dec. 30, 1999 (Attorney Docket No. 243768011US), and is related to U.S. patent application No. ______, entitled “SERIALIZATION TECHNIQUE” filed on Dec. 28, 2000 (Attorney Docket No. 243768002US1), U.S. patent application No. ______, entitled “COMMON NETWORK SECURITY” filed on Dec. 19, 2000 (Attorney Docket No. 243768005US1), U.S. patent application No. ______, entitled “RULES PROCESSING SYSTEM” filed on Dec. 28, 2000 (Attorney Docket No. 243768006US1) and U.S. patent application No. ______, entitled “OBJECT-ORIENTED INTERFACE TO LDAP DIRECTORY” filed on Dec. 28, 2000 (Attorney Docket No. 243768007US1), the disclosures of which are incorporated herein by reference.

### TECHNICAL FIELD

The described technology relates to the organization of application programs.

### BACKGROUND

Many companies are now allowing their customers to remotely access the company computer systems. These companies believe that the providing of such access will give the company an advantage over their competitors. For example, they believe that a customer may be more likely to order from a company that provides computer systems through which that customer can submit and then track their orders. The applications for these computer systems may have been developed by the companies specially to provide information or services that the customers can remotely access, or the applications may have been used internally by the companies and are now being made available to the customers. For example, a company may have previously used an application internally to identify an optimum configuration for equipment that is to be delivered to a particular customer's site. By making such an application available to the customer, the customer is able to identify the optimum configuration themselves based on their current requirements, which may not be necessarily known to the company. The rapid growth of the Internet and its ease of use has helped to spur making such remote access available to customers.

Because of the substantial benefits from providing such remote access, companies often fmd that various groups within the company undertake independent efforts to provide their customers with access to their applications. As a result, a company may find that these groups may have used very different and incompatible solutions to provide remote access to the customers. It is well-known that the cost of maintaining applications over their lifetime can greatly exceed the initial cost of developing the application. Moreover, the cost of maintaining applications that are developed by different groups that use incompatible solutions can be much higher than if compatible solutions are used. Part of the higher cost results from the need to have expertise available for each solution. In addition, the design of the applications also has a significant impact on the overall cost of maintaining an application. Some designs lend themselves to easy and cost effective maintenance, whereas iother designs require much more costly maintenance. It would be desirable to have an application architecture that would allow for the rapid development of new applications and rapid adaptation of legacy applications that are made available to customers, that would provide the flexibility needed by a group to provide applications tailored to their customers, and that would help reduce the cost of developing and maintaining the applications.

### BRIEF DESCRIPTION OF THE DRAWINGS

FIG. 1 is a block diagram illustrating uses of the application architecture in one embodiment.

FIG. 2 is a block diagram illustrating an overview of the application framework of the application architecture.

FIG. 3 is a block diagram illustrating the architecture of the application framework.

FIG. 4 is a block diagram illustrating the message translation of the application architecture.

FIG. 5 is a block diagram illustrating the processing of a request for service that is received from a client system.

FIG. 6 is a diagram illustrating the processing of a request message that is sent from a client system to the container adapter.

FIG. 7 is a block diagram illustrating action components of the action layer of an application program.

FIG. 8 is a block diagram illustrating the processing of a request message by the action layer.

FIG. 9 is a block diagram illustrating the dynamic dispatching of an action.

FIG. 10 is a block diagram illustrating the view components of the view layer.

FIG. 11 is a block diagram illustrating the processing of a view request object by a view handler.

FIG. 12 is a block diagram illustrating the configuration state architecture for an application program.

FIG. 13 is a block diagram illustrating the organization of a configuration file of an application program.

FIG. 14 is a block diagram illustrating the layout of the action table of the application framework.

FIG. 15 is a block diagram of the layout of the translation table of the application framework.

FIG. 16 is a block diagram illustrating the layout of the view table of the application framework.

FIG. 17 is a flow diagram illustrating the initialization of an application program by the container adapter.

FIG. 18 is a flow diagram of the get instance method of the application manager factory object.

FIG. 19 is a flow diagram of the processing of the load components finction.

FIG. 20 is a flow diagram of the processing of the load view components function.

FIG. 21 is a flow diagram of the processing of the load action components function.

FIG. 22 is a flow diagram of the processing of the load translation components function.

FIG. 23 is a flow diagram of the processing of the service method of an application service manager object.

FIG. 24 is a flow diagram illustrating the processing of the service method of an action handler.

FIG. 25 is a block diagram illustrating the architecture of the service framework in one embodiment.

FIG. 26 is a block diagram illustrating the architecture of the service framework.

FIG. 27 is a block diagram illustrating the configuring of the service framework.

FIG. 28 is a block diagram illustrating a service table in one embodiment.

FIG. 29 is a flow diagram illustrating the processing of the register service method of the service manager object in one embodiment.

FIG. 30 is a flow diagram illustrating the processing of the create service method in one embodiment.

FIG. 31 is a flow diagram of the lookup method of the environmental context object.

FIG. 32 is a block diagram illustrating invocation of the serialization service.

FIG. 33 is a block diagram illustrating the architecture of the serialization service in one embodiment.

FIG. 34 is a flow diagram illustrating the initialize method of the serialization service in one embodiment.

FIG. 35 is a flow diagram illustrating the processing of the decode to Java method of a translator in one embodiment.

FIG. 36 is a flow diagram illustrating the processing of the read object method of the serialization service in one embodiment.

FIG. 37 is a block diagram illustrating the architecture of the configuration service in one embodiment.

FIG. 38 is a flow diagram illustrating a get configuration as objects method of the configuration service in one embodiment.

### DETAILED DESCRIPTION

An application architecture for developing applications for a computer system is provided. In one embodiment, the application architecture includes an application framework and applications. An application includes action handlers and view handlers. The action handlers implement the business logic of the application, and the view handlers control the formatting of the results returned by the business logic. The application framework receives requests for services from client computers (e.g., customer computers), identifies the action handlers that can service the requests, invokes the identified action handlers to service the requests to generate responses, identifies view handlers for formatting the responses, and invokes identified view handlers to format the responses and to send the responses to the client computers. The action handlers may also indicate a presentation view that specifies the way in which the responses are to be presented to the client systems. For example, a presentation view may indicate that a response is to be displayed in accordance with the layout of a certain web page. The applications may also include translators for translating requests into a format that is suitable for processing by the action handlers. For example, a client computer may provide requests using an HTTP protocol, whereas an action handler may be developed to process requests using the XML protocol. In such a case, a translator would translate the requests in the HTTP protocol to the XML protocol. The use of translators allows the applications to be developed independently of the protocols actually used by the client computers. In addition, new protocols that are used by client computers can be accommodated by developing additional translators without the need to modifying the action handlers that implement the business logic.

In one embodiment, the application architecture also provides a service framework through which an application can access services common to other applications in a way that is independent of the container (e.g., operating environment) in which the application framework executes. The service framework loads service components as indicated by configuration information, which includes the names of the services and implementations of the services. The service framework provides an interface through which an application can retrieve references to the implementations of the various services. To retrieve an implementation, the application (e.g., action handler or view handler) provides the name of the desired service to the service framework. The service framework looks up the implementation for the service of that name and returns to the application a reference to the implementation. The application can then use the reference to directly invoke the implementation of that service.

In one embodiment, the application architecture allows the applications to be loaded based on information stored in configuration files. The information in the configuration files may defme the translators, action handlers, and view handlers of an application. The configuration information may specify the types of requests that may be received by the application and specify the action handler that is to service each request. The configuration information may also specify what translators should be used to convert a request from a protocol used by a client computer to a protocol used by an action handler. In addition, the configuration information may be hierarchically organized. That is, some configuration information may be global to all applications that use the application architecture, and other configuration information may be specific to a particular application. The configuration information that is specific to a particular application would, in general, override the configuration information that is global to all applications.

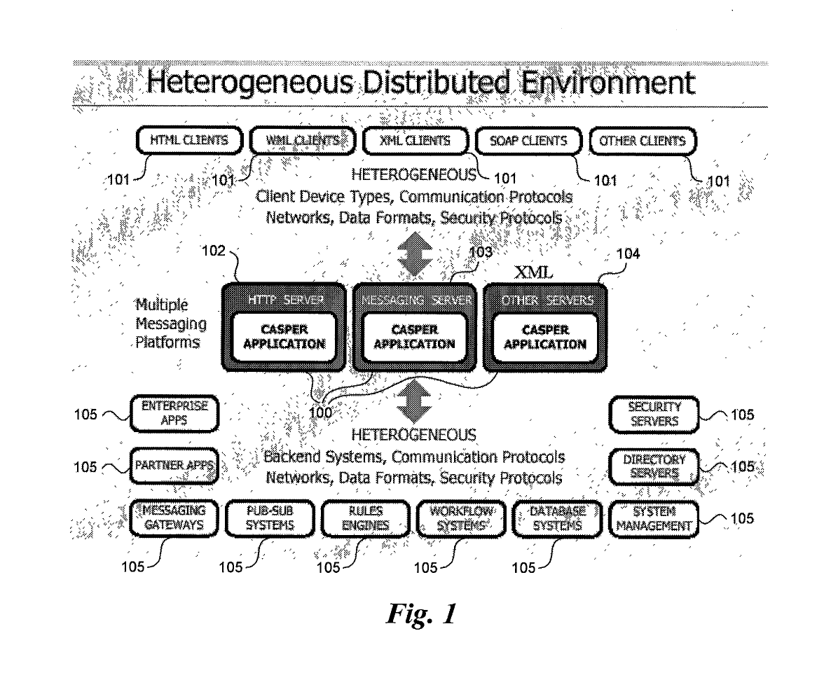

FIG. 1 is a block diagram illustrating uses of the application architecture in one embodiment. The application architecture allows an application program to provide its services to various client systems 101 that use differing communication protocols. For example, one client system may communicate with the application program using the HTML protocol, and another client system may communicate with the application program using the XML protocol. The application architecture facilitates the development of application programs whose business logic is independent of the protocol used by the client systems. The application programs 100 includes such business logic that interacts with the client systems through various servers such as HTTP server 102, messaging server 103, and XML server 104. The application architecture also facilitates the development of application programs that use various services 105, such as legacy applications and database systems. In particular, the application architecture defines an interface through which the application programs can access these services.

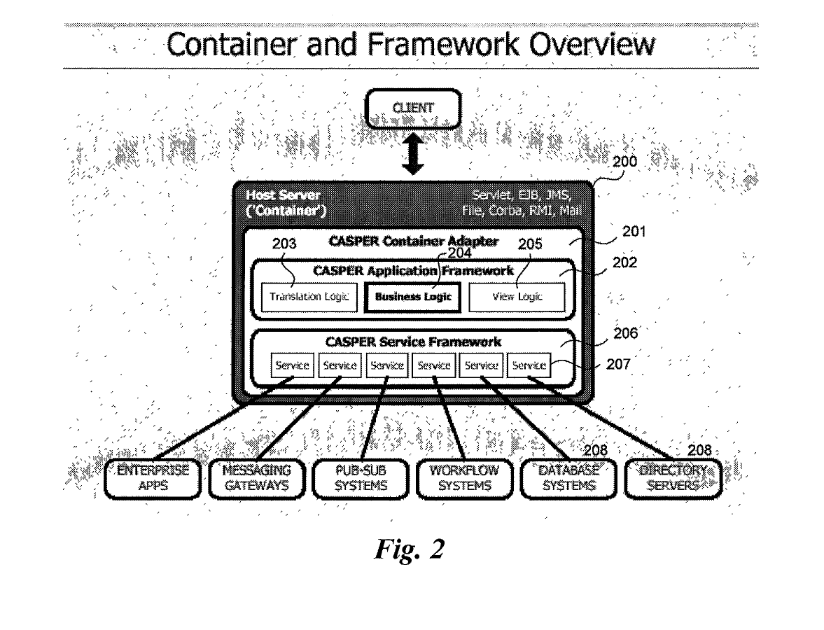

FIG. 2 is a block diagram illustrating an overview of the application framework of the application architecture. The application programs execute in a container environment 200, such as the Common Object Request Broker Architecture (“CORBA”) or the remote messaging interface (“RMI”) environments. The application architecture specifies that container adapters 201 serve as an interface between the various containers and the application framework 202. That is, a different implementation of a container adapter is used for each possible container. In this way, the application programs can be independent of the type of container. The application framework defines the interface between the container adapter and the application program itself. The application architecture specifies that an application program is divided into translation logic 203, business logic 204, and view logic 205. The business logic receives requests for service in an application format, services the requests, and provides responses to the requests in an application format. The translation logic is responsible for translating the requests received from a client system in a lo client format into the application format defined for the business logic. The view logic is responsible for generating and sending a response that is in the client format using the view and response specified by the business logic. The translation logic, business logic, and view logic may use the services of the service framework 206 to implement their functionality. The service framework defines a common interface that the application programs can use to access various services such as database systems and directory servers 208.

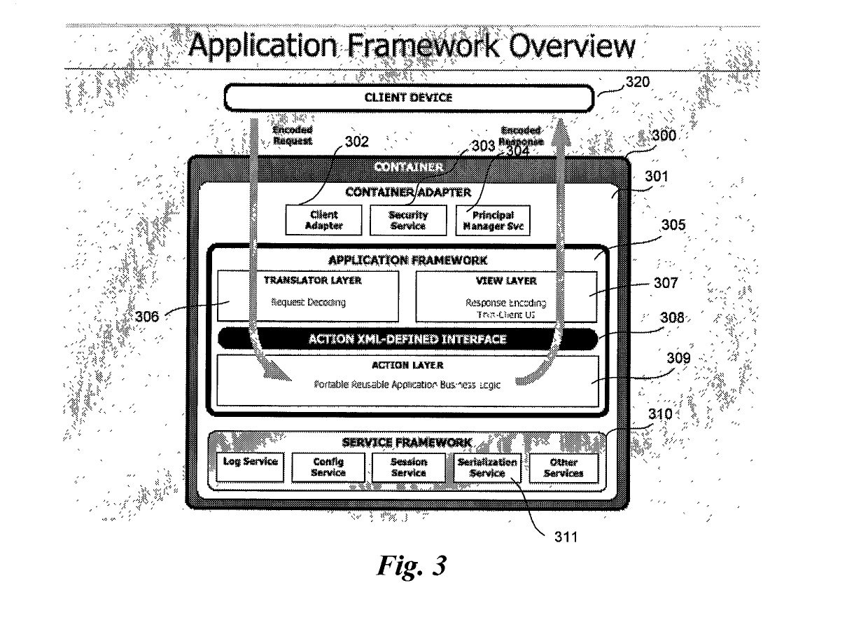

FIG. 3 is a block diagram illustrating the architecture of the application framework. A client system 320 requests services of an application program by sending request messages in a client format to the application program and receives results of the services in response messages in a client format. A container 300 receives the request messages and forwards them to container adapter 301 and receives response messages from the container adapter and forwards them to the client system. The container adapter includes a client adapter component 302, a security service component 303, and the principal managers service 304. The application framework includes translation layer 306, a view layer 307, and action layer 309. The action layer, view layer, and translation layer may invoke the services of the service framework 310 such as serialization service 311. The translation layer translates request messages in the client format into the application format and the view layer converts response messages in the application format into the client format.

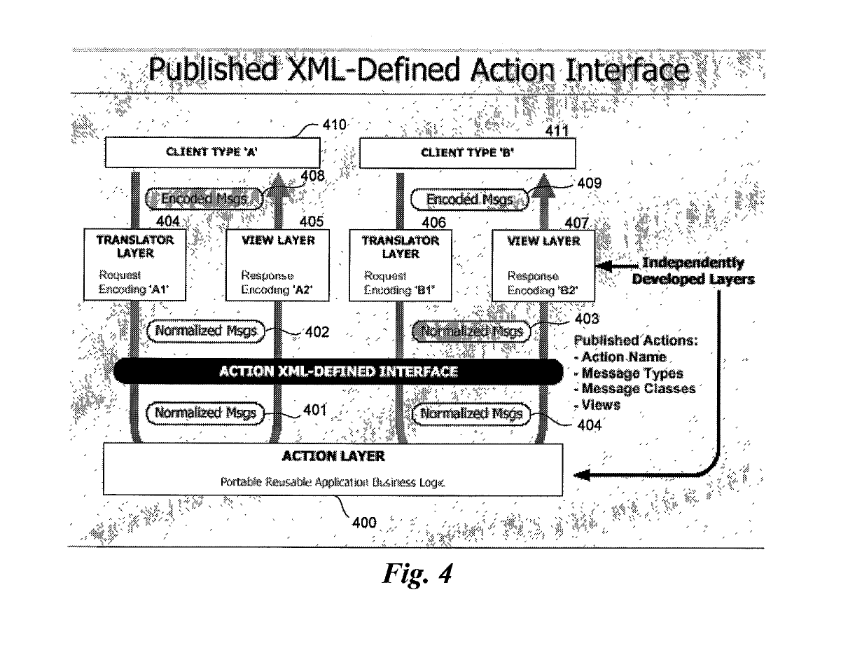

FIG. 4 is a block diagram illustrating the message translation of the application architecture. The client systems 410 and 411 are developed to use the business logic provided by action layer 400. Each client system, however, may use a different messagmg protocol (i.e., client format) to communicate with the business logic. A message in a client format is also referred to as an “encoded message,” and a message in an application format is also referred to as a normalized message of a certain “message type.” When the translation layer 404 receives a request message from the client system 410, it translates the request message into the application format. In one embodiment, the application architecture defines two normalized formats for the application format. One normalized format is an XML-based format and the other normalized format uses an object through which attributes of the message can be retrieved. The action layer inputs a request message in the normalized format, performs its business logic, and outputs a response message in the normalized format. The view layer 405 is responsible for converting the response message from the normalized format to the client format 408. The processing of request messages from client system 411 is similar to the processing of request messages from client system 410, except that the client formats of the request and response messages may be different.

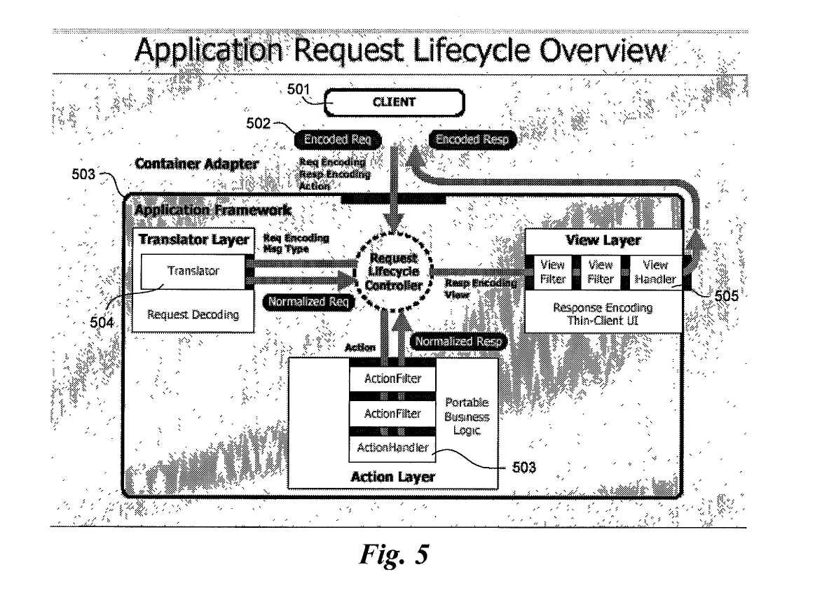

FIG. 5 is a block diagram illustrating the processing of a request message that is received from a client system. The client system 501 sends a request message 502 in the client format. The request message specifies the client format for the response message and the action to be performed by the application program. When the application program is loaded, it registers with the application framework its components that implement the translation layer, action layer, and view layer. In one embodiment, the action layer includes an action handler for each action that is serviced by the application. Similarly, the view layer may include multiple view handlers, and the translation layer may use multiple translators. When the application framework 503 receives a request message, it identifies which action handler is responsible for servicing the action of the request message. The application framework may also identify a translator 504 that can translate the request message from the client format to the application format needed by the identified action handler. The application framework then forwards the request message to the action handler. The action handler uses the translator to translate that request message to the appropriate normalized format. The action handler performs its business logic and supplies its response message in the appropriate normalized format to the application framework. The application framework then forwards the response message and view specified by the action handler to view handler 505 that is responsible for generating and sending the response message to the client system. Each action handler and view handler may have filters associated with it for preprocessing and postprocessing of the request and response messages. For example, a filter of an action handler may be responsible for logging each request message and response message.

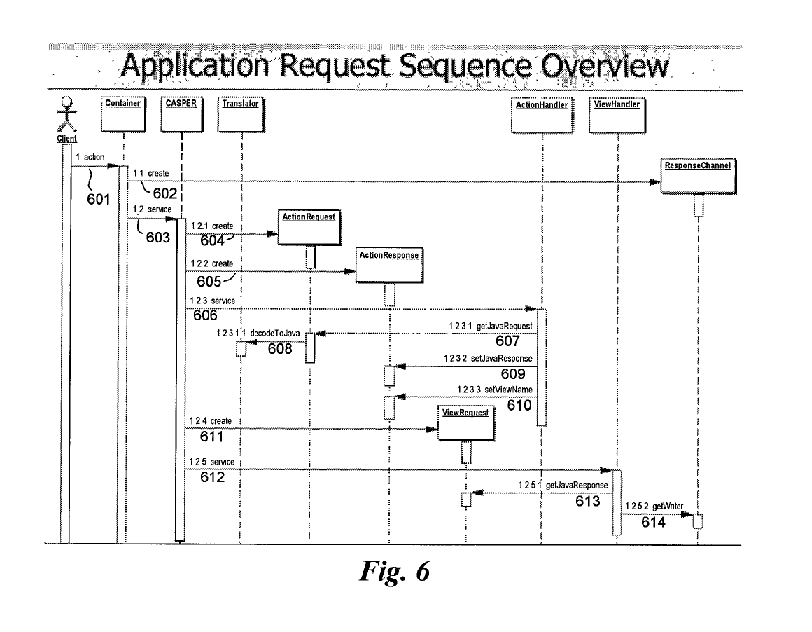

FIG. 6 is a diagram illustrating the processing of a request message that is sent from a client system to the container adapter. The client system initially sends 601 a request message that specifies an action to be performed by the application program and the client format of the response message. When the container adapter receives the request message, it creates 602 a response channel object, which the application program uses to transmit the response message to the client system. The response channel object includes sufficient information (e.g., address of client system) so that the response message can be sent to the client system. The container adapter then requests 603 the application framework to service the request message passing both the response channel object and the request message. The application framework creates 604 an action request object through which the request message in either normalized format can be accessed. The application framework also creates 605 an action response object for holding the response message of the application program. The application framework then identifies the action handler that can service the requested action. The application framework then identifies the translator for translating the request message in the client format to the normalized format needed by the identified action handler and stores an indication of that translator in the action request object. The application framework requests 606 the action handler to perform that action. The application framework passes to the action handler the response channel object, action request object, and action response object. To process the message, the action handler requests 607 the action response object to convert the request message to the normalized format. The action response object in turn requests 608 the translator to convert the request message to the normalized format. The action handler then performs its business logic. When the action handler completes performance of its business logic, it stores 609 the response message in the action response object and stores 610 the view in the action response object. The action handler then returns to the application framework. The application framework creates 611 a view request object that identifies the view, the response message, and the client format for the response message. The application framework then identifies the view handler for processing of the view request and requests 612 the identified view handler to service the view request. The application framework passes the view request object, the action request object, and the response channel object to the view handler. The view handler retrieves the view from the view request object and retrieves 613 the response message from the action response object. The view handler converts the response message from the normalized format to the client format in accordance with the view. The view handler then sends 614 the response message to the client system using the response channel object.

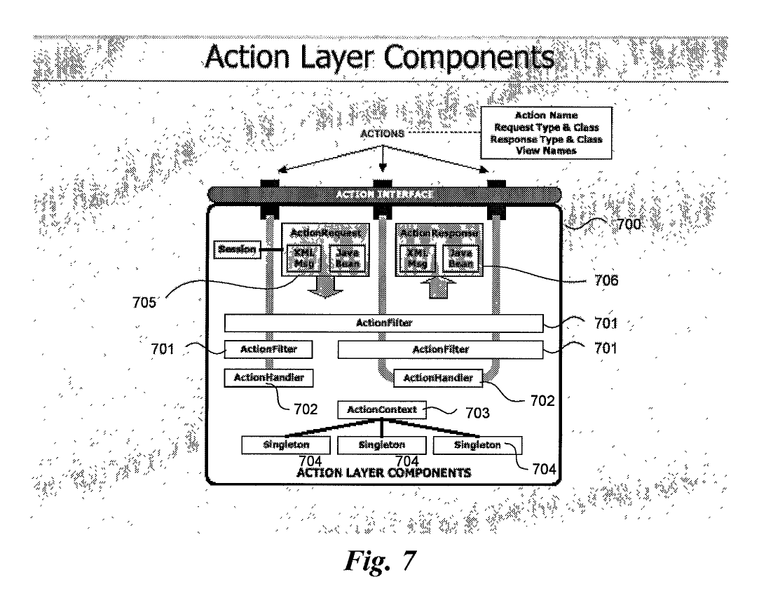

FIG. 7 is a block diagram illustrating action components of the action layer of an application program. The action components may include various action filters 701 that perform preprocessing of a request message and postprocessing of a response message for an action handler. The action components also include various action handlers 702. The action filters and action handlers may use the services of an action context object 703 that provides context information that is common to the action components of the action layer. The action context object provides access to common information such as configuration information and parameters. The configuration information and parameters may be represented by singleton objects 704. (A singleton object is the only object that is instantiated for a particular class.) The action request object 705 and the action response object 706 provide access to the response and request messages in a normalized format. In one embodiment, two normalized formats are provided: an XML-based format and a JavaBean-based format.

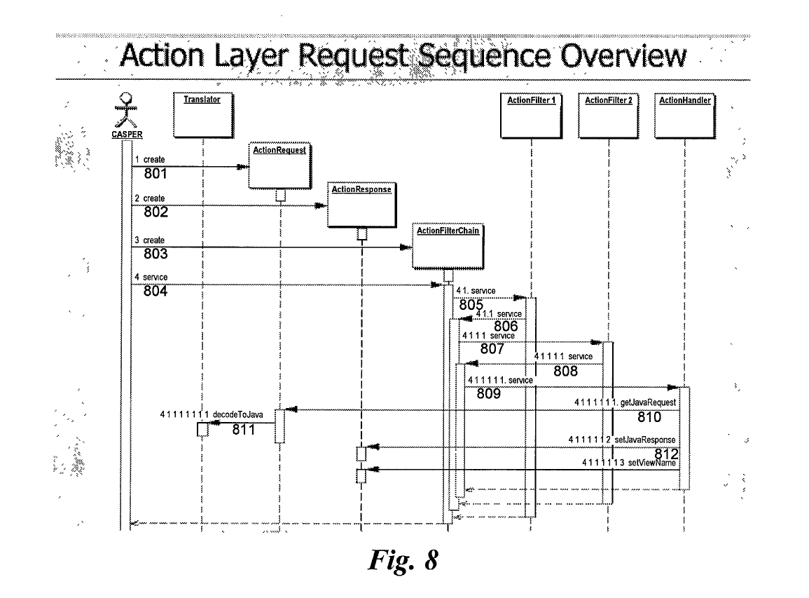

FIG. 8 is a block diagram illustrating the processing of a request message by the action layer. As discussed above, when the application framework receives a request message, it creates 801 an action request object and creates 802 an action response object. The application framework then identifies the action handler that is to process the request message. The application framework creates 803 an application filter chain object for the application handler. The action filter chain object controls the invocation of each of the filters in sequence followed by invocation of the action handler. The application framework requests 804 the action filter chain object to service the message request. The action filter chain object then requests 805 the first action filter to service the request. The first action filter performs its preprocessing of the request message and recursively requests 806 the action filter chain object to continue servicing the request message. The action filter chain object then requests 807 the second action filter object to service the message request. This invoking of action filters continues until the last action filter is invoked. The second action filter performs its preprocessing of the request message and then recursively requests 808 the action filter chain to continue servicing the request message. This invoking of action filters continues until the last action filter is invoked. The action filter chain object then requests 809 the action handler to service the request message. The action handler requests 810 the action request object to translate the request message from the client format to the normalized format. The action request object requests 811 the translator to perform the translation. The action handler then performs its business logic on the translated request message. The action handler then stores 812 the response message in the normalized format and stores 813 the view in the action response object. The action handler then returns to the action filter chain object, which returns controls to the second action filter for performing its postprocessing of the response message. The second action filter returns to the action filter lo chain object, which returns to the first action filter for performing its postprocessing of the response message. The first action filter then returns to the action filter chain object, which returns to the application framework to complete the processing.

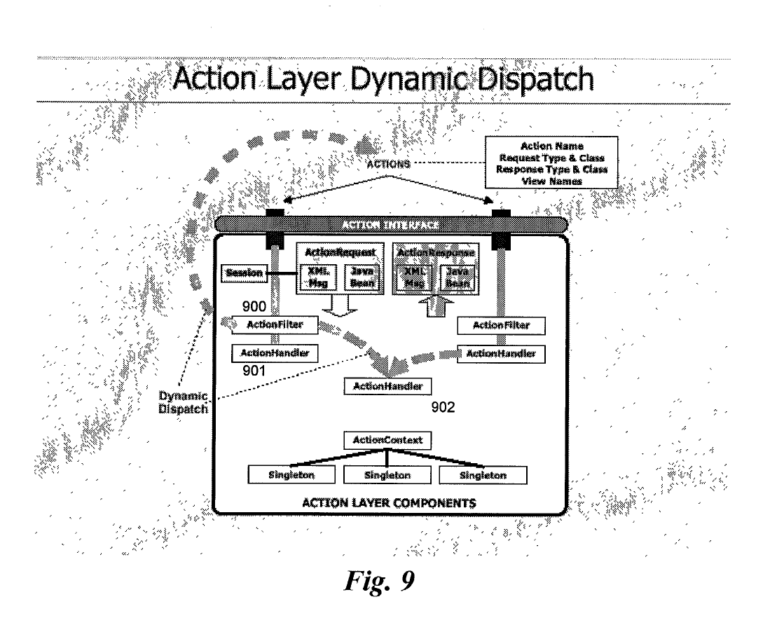

FIG. 9 is a block diagram illustrating the dynamic dispatching of an action. Dynamic dispatching refers to the process in which one action component requests an action handler to perform some action on its behalf In one embodiment, an action handler or an action filter can dynamically dispatch actions to an action handler. Action handler 901 may have been originally designed to process a request for a certain action. If action filter 900 is later installed, then that action filter may receive the message request and dynamically dispatch it to a different action handler, such as action handler 902. The action filter can dispatch the request message to action handler 902 either by invoking action handler 902 directly or by sending the request message with a different action to the application framework for processing.

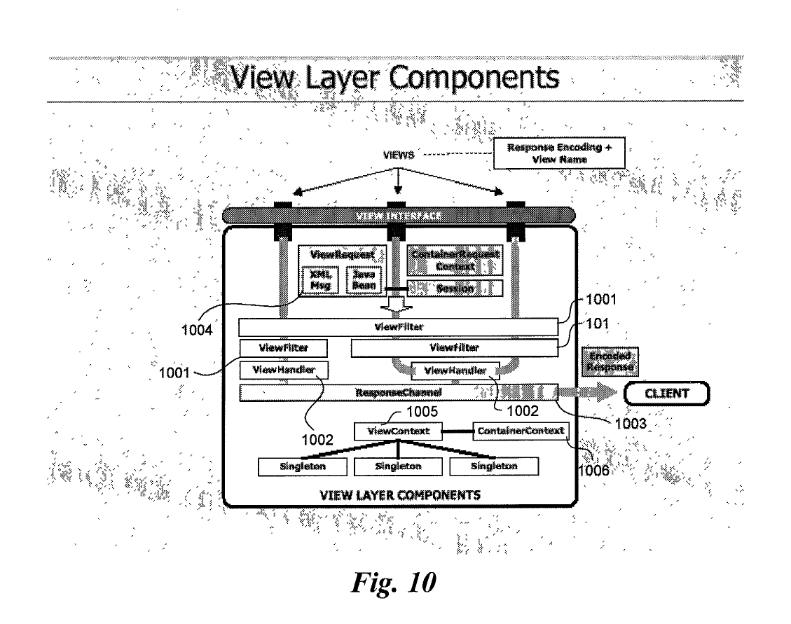

FIG. 10 is a block diagram illustrating the view components of the view layer. The view components include view filters 1001 and the view handlers 1002. The view components also include response channel object 1003 that is passed to the application framework by the container adapter. The view components access the response message using the view request object 1004. When the view handler is invoked, it is passed a view request message that is processed by the view filters (if any) first. The view handler then uses the response channel object to forward the request message in the client format to the client system. The view components may also include a view context object 1005 through which the view components can access information that is common to the view layer. The view context object may also provide access to a container context that provides access to information relating to the container.

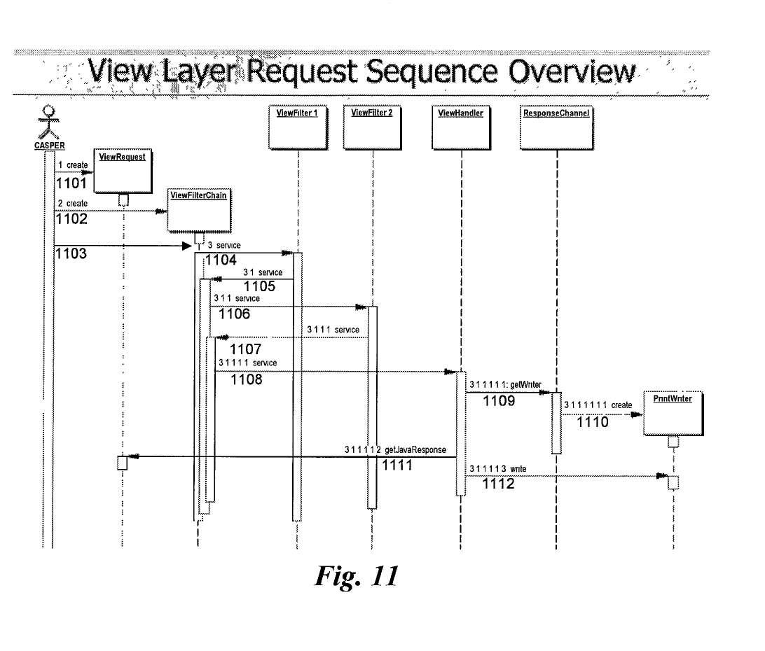

FIG. 11 is a block diagram illustrating the processing of a view request object by a view handler. When that the application framework receives a response message from the action layer, it creates 1101 a view request object. The application framework then identifies the view handler that is to process the response message. The application framework creates 1102 a view filter chain object for controlling the invocation of the filters and the view handler. The application framework requests 1103 the view filter chain object to service to the view request message. The view filter chain object then requests 1104 the lo first view filter to service the view request object. The first view filter performs its preprocessing and recursively requests 1105 the view filter chain object to service the view request object. The view filter chain object then requests 1106 the second view filter to process the view request message. The second view filter then performs its preprocessing of the view request message and recursively requests 1107 the view filter chain object to service the view message request. This invoking of view filters continues until the last view filter is invoked. The view filter chain object then requests 1108 the view handler to service the view request object. The view handler then requests 1109 the response channel object to provide a print writer object. The response channel object creates 1110 the print writer object and returns a reference to the print writer object. The view handler then retrieves 1111 the response message, view, and client format for the response message from the view request object. The view handler prepares the response message in accordance with the view and sends 1112 the response message to the client system using the print writer object. The view handler then returns to the view filter chain object which returns to the second view filter, which performs its postprocessing and then returns to the view filter chain object. The view filter chain object then returns to the first view filter, which performs its postprocessing and then returns to the view filter chain object. The view filter chain object then returns to the application framework to complete the processing.

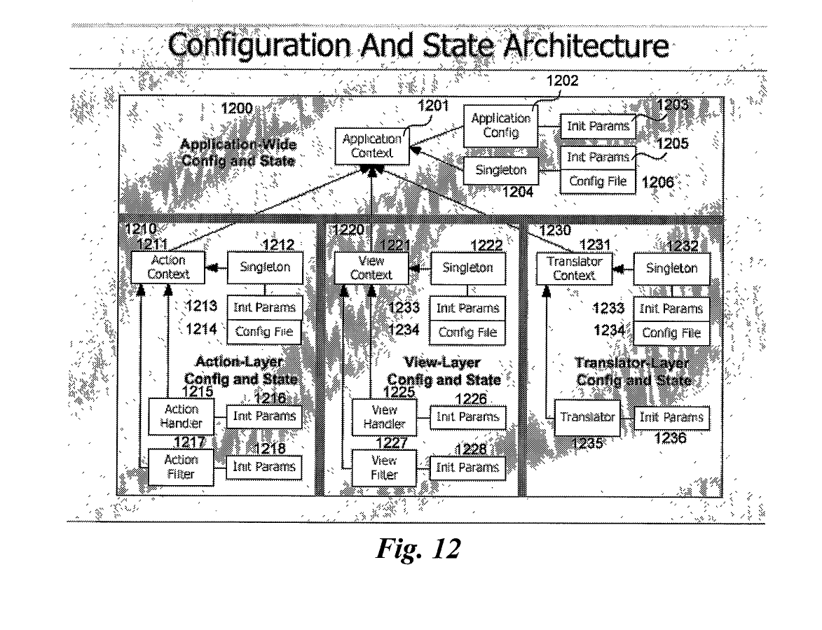

FIG. 12 is a block diagram illustrating the configuration and state architecture for an application program. The application program contains application-wide configuration and state information 1200, action layer configuration and state information 1210, view layer configuration state information 1220, and translation layer configuration and state information 1230. The application-wide configuration and state information is represented by application context object 1201 that provides access to an application configuration object 1202 and various singleton objects 1204. The application configuration object provides access to the configuration information that specify initialization parameters 1203 of the application program. The singleton objects provide access to initialization parameters 1205 and the configuration file information 1206. The action layer, view layer, and translation layer have access to the application context object. The action layer includes configuration and state information that is common to all the action components. The action context object 1211 provides access to various singleton objects 1212. Each singleton object may provide access to initialization parameters 1213 and configuration file information 1214 for the action layer. The action context object also provides access to the action handlers 1215 and the action filter 1217. The action handlers have access to initialization parameters 1216, and the action filters have access to initialization parameters 1218. The view layer include configuration and state information that is common to all view components. The organization of the configuration state information of the view layer is similar to that of the action layer. The translation layer also includes configuration and state information that is common to all translators. The organization of the configuration and state information of the translation layer is similar to that of the action layer except that filters are not defmed for translators.

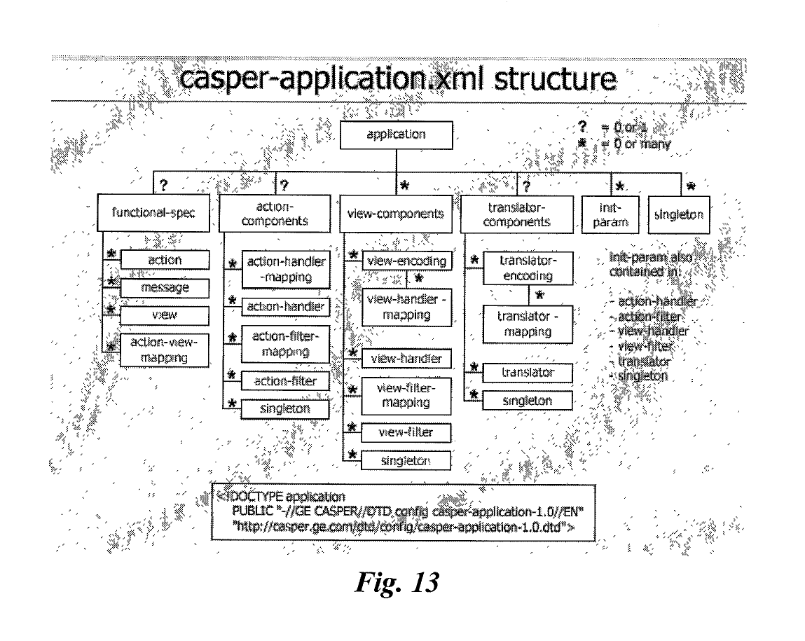

FIG. 13 is a block diagram illustrating the organization of a configuration file of an application program in one embodiment. The configuration file includes a functional specification section, an action components section, a view components section, a translation components section, an initialization parameters section, and a singleton section. The functional specification section may defme the actions, messages, views, and action-to-view mappings used by the application program. The action components section defines action handler mappings, action handlers, action filter mappings, action filters, and singletons. The view components section defines the view encodings and view handler mappings, view handlers, view filter mappings, view filters, and singletons. The translator component section defines the translator encoding and translator mappings, translators, and singletons.

Table 1 contains an example configuration file.

| | |
|---|---|
| 1 | <?xml version=“1.0” encoding=“ISO-8859-1”?> |
| 2 | <!DOCTYPE application |
| 3 | PUBLIC “-//GE CASPER//DTD config |
| | casper-application-1.0//EN” |
| 4 | “http://casper.ge.com/dtd/config/casper-application-1.0.dtd”> |
| 5 | <application |
| 6 | name=“sample-app03” |
| 7 | description=“Sample Application 3” |
| 8 | msg-serialization-service=“sfo-xml-serialization”> |
| 9 | <!-- |
| 10 | ================================================= |
| 11 | FUNCTIONAL SPECIFICATION |
| 12 | ================================================= |
| 13 | --> |
| 14 | <functional-spec> |
| 15 | <!--Actions--> |
| 16 | <action name=“get-cart” |
| 17 | rsp-type=“cart-contents-rsp”/> |
| 18 | <action name=“get-catalog” |
| 19 | rsp-type=“catalog-contents-rsp”/> |
| 20 | <action name=“get-product” |
| 21 | req-type=“get-product-req” rsp-type=“product-description-rsp”/> |
| 22 | <action name=“add-product” |
| 23 | req-type=“add-product-req” rsp-type=“update-cart-rsp”/> |
| 24 | <action name=“del-product” |
| 25 | req-type=“del-product-req” rsp-type=“update-cart-rsp”/> |
| 26 | <action name=“NULL”/> |
| 27 | |
| 28 | <!--Views--> |
| 29 | <view name=“cart-view”/> |
| 30 | <view name=“catalog-view”/> |
| 31 | <view name=“product-view”/> |
| 32 | <view name=“cart-updated-view”/> |
| 33 | <view name=“welcome-view”/> |
| 34 | |
| 35 | <!--Action-View-Mappings--> |
| 36 | <action-view-mapping action=“get-cart”> |
| 37 | <view name=“cart-view”/> |
| 38 | </action-view-mapping> |
| 39 | <action-view-mapping action=“get-catalog”> |
| 40 | <view name=“catalog-view”/> |
| 41 | </action-view-mapping> |
| 42 | <action-view-mapping action=“get-product”> |
| 43 | <view name=“product-view”/> |
| 44 | </action-view-mapping> |
| 45 | <action-view-mapping action=“add-product”> |
| 46 | <view name=“cart-updated-view”/> |
| 47 | </action-view-mapping> |
| 48 | <action-view-mapping action=“del-product”> |
| 49 | <view name=“cart-updated-view”/> |
| 50 | </action-view-mapping> |
| 51 | <action-view-mapping action=“NULL”> |
| 52 | <view name=“welcome-view”/> |
| 53 | </action-view-mapping> |
| 54 | </functional-spec> |
| 55 | <!-- |
| 56 | ================================================= |
| 57 | ACTION COMPONENT CONFIGURATION |
| 58 | ================================================= |
| 59 | --> |
| 60 | <action-components> |
| 61 | <!--Action Handler Mappings--> |
| 62 | <action-handler-mapping |
| 63 | action=“get-cart” class-name=“sample.app03.action.GetCart”/> |
| 64 | <action-handler-mapping |
| 65 | action=“get-catalog” class-name= |
| | “sample.app03.action.GetCatalog”/> |
| 66 | <action-handler-mapping |
| 67 | action=“get-product” class-name= |
| | “sample.app03.action.GetProduct”/> |
| 68 | <action-handler-mapping |
| 69 | action=“add-product” class-name= |
| | “sample.app03.action.AddProduct”/> |
| 70 | <action-handler-mapping |
| 71 | action=“del-product” class-name= |
| | “sample.app03.action.DelProduct”/> |
| 72 | <action-handler-mapping |
| 73 | action=“NULL” handler=“null-handler”/> |
| 74 | |
| 75 | <!--Action Handlers--> |
| 76 | |
| 77 | <action-handler name=“null-handler” |
| 78 | class-name=“sample.app03.action.NullActionHandler”> |
| 79 | <init-param name=“view” value=“welcome-view”/> |
| 80 | </action-handler> |
| 81 | <!--Action Filter Mappings--> |
| 82 | <action-filter-mapping action=“*”> |
| 83 | <action-filter-ref class-name=“sample.app03.action.LogFilter”/> |
| 84 | <action-filter-ref class-name=“sample.app03.action.AuditFilter”/> |
| 85 | </action-filter-mapping> |
| 86 | |
| 87 | <!--Action Singletons--> |
| 88 | |
| 89 | <singleton |
| 90 | class-name=“sample.app03.action.SharedActionResources” |
| 91 | config=“product-catalog.xml” |
| 92 | config-serialization-service=“sfo-xml-serialization”> |
| 93 | </singleton> |
| 94 | </action-components> |
| 95 | <!-- |
| 96 | ================================================= |
| 97 | VIEW COMPONENT CONFIGURATION |
| 98 | ================================================= |
| 99 | --> |
| 100 | <!-- |
| | ================================================= |
| 101 | Portable View Components |
| 102 | --> |
| 103 | <view-components> |
| 104 | <!--View Handler Mappings--> |
| 105 | <view-encoding encoding=“html”> |
| 106 | <view-handler-mapping |
| 107 | view=“$java.lang.Exception” |
| 108 | class-name=“sample.app03.view.SystemErrorView”/> |
| 109 | <view-handler-mapping |
| 110 | view=“$com.ge.casper.app.translator.TranslationException” |
| 111 | class-name=“sample.app03.view.TranslationErrorView”/> |
| 112 | </view-encoding> |
| 113 | <!--Singletons--> |
| 114 | |
| 115 | <singleton |
| 116 | class-name=“sample.app03.view.SharedViewResources”> |
| 117 | <init-param name=“foo” value=“bar”/> |
| 118 | </singleton> |
| 119 | </view-components> |
| 120 | <!-- |
| | ================================================= |
| 121 | http-servlet View Components |
| 122 | --> |
| 123 | <view-components container-type=“http-servlet”> |
| 124 | <!--View Handler Mappings--> |
| 125 | <view-encoding encoding=“html”> |
| 126 | <view-handler-mapping |
| 127 | view=“cart-view” handler=“html-cart-view”/> |
| 128 | <view-handler-mapping |
| 129 | view=“cart-updated-view” handler=“html-cart-updated-view”/> |
| 130 | <view-handler-mapping |
| 131 | view=“catalog-view” handler=“html-catalog-view”/> |
| 132 | <view-handler-mapping |
| 133 | view=“product-view” handler=“html-product-view”/> |
| 134 | <view-handler-mapping |
| 135 | view=“welcome-view” handler=“html-welcome-view”/> |
| 136 | </view-encoding> |
| 137 | <!--View Handlers--> |
| 138 | <view-handler |
| 139 | name=“html-cart-view” |
| 140 | class-name=“sample.app03.view.jsp.CartJspPreparer”> |
| 141 | <init-param name=“jsp” value=“/html/cart-view.jsp”/> |
| 142 | </view-handler> |
| 143 | <view-handler |
| 144 | name=“html-cart-updated-view” |
| 145 | class-name=“sample.app03.view.http.HttpRedirector”> |
| 146 | <init-param name=“action” value=“get-cart”/> |
| 147 | </view-handler> |
| 148 | <view-handler |
| 149 | name=“html-catalog-view” |
| 150 | class-name=“sample.app03.view.jsp.CatalogJspPreparer”> |
| 151 | <init-param name=“jsp” value=“/html/catalog-view.jsp”/> |
| 152 | </view-handler> |
| 153 | <view-handler |
| 154 | name=“html-product-view” |
| 155 | class-name=“sample.app03.view.jsp.ProductJspPreparer”> |
| 156 | <init-param name=“jsp” value=“/html/product-view.jsp”/> |
| 157 | </view-handler> |
| 158 | <view-handler |
| 159 | name=“html-welcome-view” |
| 160 | class-name=“sample.app03.view.jsp.NoOpJspPreparer”> |
| 161 | <init-param name=“jsp” value=“/html/index.jsp”/> |
| 162 | </view-handler> |
| 163 | <!--View Filter Mappings--> |
| 164 | <view-filter-mapping encoding=“*” view=“*”> |
| 165 | <view-filter-ref class-name=“sample.app03.view.LogFilter”/> |
| 166 | <view-filter-ref class-name=“sample.app03.view.AuditFilter”/> |
| 167 | </view-filter-mapping> |
| 168 | |
| 169 | </view-components> |
| 170 | <!-- |
| 171 | ================================================= |
| 172 | TRANSLATOR COMPONENT CONFIGURATION |
| 173 | ================================================= |
| 174 | --> |
| 175 | <translator-components> |
| 176 | <!--Encodings--> |
| 177 | <translator-encoding encoding=“nvpair”> |
| 178 | <translator-mapping |
| 179 | message-type=“ANY” |
| 180 | class-name=“sample.app03.translator.NvPairTranslator”/> |
| 181 | </translator-encoding> |
| 182 | <!--Singletons--> |
| 183 | |
| 184 | <singleton |
| 185 | class-name=“sample.app03.translator.SharedTranslatorResources”> |
| 186 | <init-param name=“foo” value=“bar”/> |
| 187 | </singleton> |
| 188 | </translator-components> |
| 189 | <!-- |
| 190 | ================================================= |
| 191 | APPLICATION-WIDE INITIALIZATION PARAMETERS |
| 192 | ================================================= |
| 193 | --> |
| 194 | <init-param name=“param1” value=“value1”/> |
| 195 | <init-param name=“param2” value=“value2”/> |
| 196 | <!-- |
| 197 | ================================================= |
| 198 | APPLICATION-WIDE SINGLETONS |
| 199 | ================================================= |
| 200 | --> |
| 201 | <singleton |
| 202 | class-name=“sample.app03.AppContextListener”> |
| 203 | <init-param name=“foo” value=“bar”/> |
| 204 | </singleton> |
| 205 | </application> |

Lines 14-26 specify the actions supported by the application. For example, lines 20 and 21 indicate that a “get-product” action is supported and that its request message type is “get-product-req” and its response message type is “production-description-rsp.” Lines 28-33 specify the view supported by the application. For example, line 31 indicates that one view is named “product-view.” Lines 35-53 specify acfion-to-view mappings. For example, lines 42-44 indicate that the “get-product” action uses the “product-view.” Lines 60-94 specify the action components. Lines 62-80 specify the implementing class for each action handler. For example, lines 66-67 indicate that the “get-product” action is implemented by the “sample.app03.action.GetProduct” class. Lines 81-85 specify the sses of the action filters and to which actions the filters are to be applied. Line 82 indicates by the “*” that the filters apply to each action. Lines 89-93 specify singletons for the action layer. For example, lines 89-93 indicate that one singleton is specified with an implementing class of “sample.app03.action.SharedActionResources,” with a configuration file of “product-catalog.xml,” and with a configuration serialization service of “sfo-xml-serialization.” Lines 103-169 specify the view components of the application. Lines 123-126 specify a client format (e.g., HTML) and the associated views and view handlers. For example, lines 132-133 indicate that the combination of the “html” client format and the “product-view” view are associated with the “html-product-view” handler. Lines 138-162 specify the implementing classes of the view handlers. For example, lines 153-157 indicate that “html-product-view” view has the “sample.app03.viewjsp.ProductJspPreparer” implementing class with a name-value pair initialization parameter of “jsp-/html/product-viewjsp.” Lines 175-188 specify the translator components for the application. For example, lines 177-181 indicate that a message encoding of “nvpair” to any message type uses the translator implemented by the “sample.app03.translator.NvPairTranslator” class.

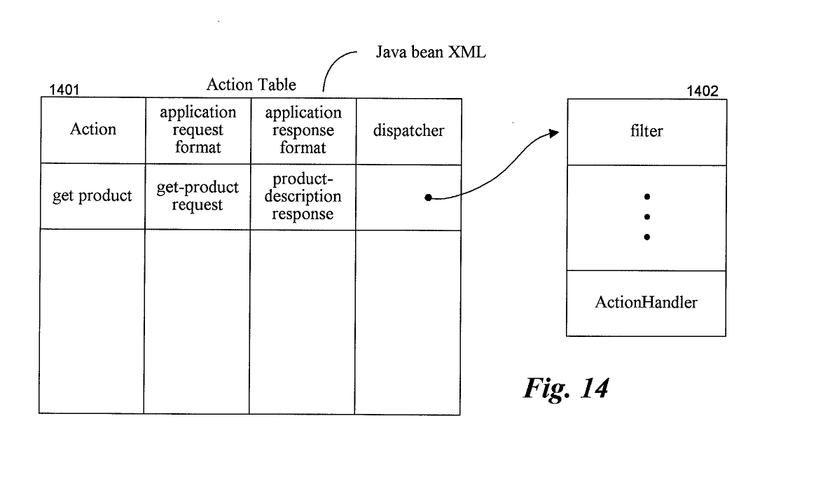

FIG. 14 is a block diagram illustrating the layout of the action table of the application framework. The application framework generates the action table based on the information contained in the configuration file. The action table 1401 contains an entry for each action that is defined in the configuration file. The action table contains the name of the action, the application format of the request message, the application format of the response message, and a reference to the dispatcher for that action handler. For example, the first entry of the action table indicates that the action name is “get-product-req,” the request format is “get-product-req,” and the response format is “product-description-rsp.” The dispatcher is responsible for invoking the filters in sequence and then the action handler as indicated by the action component table 1402. The configuration file identifies the class of each action filter and handler, and during initialization, the application manager object instantiates an object of the class for each action filter and handler and stores reference to a dispatch method that controls the invoking of the action filters and then the action handler.

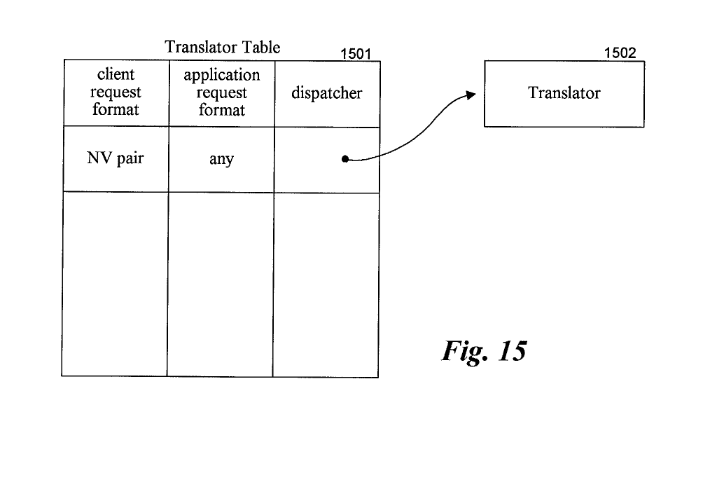

FIG. 15 is a block diagram of the layout of the translation table of the application framework. The application framework generates the translation table based on the information contained in the configuration file. The translation table 1501 contains an entry for each translator that is defined in the configuration. The entries contain the client format of the request message, the application format of the request message, and a dispatcher for the 1502. For example, the first entry of the translation table indicates that the client request format is “nvpair” and that the application request format is “any.”

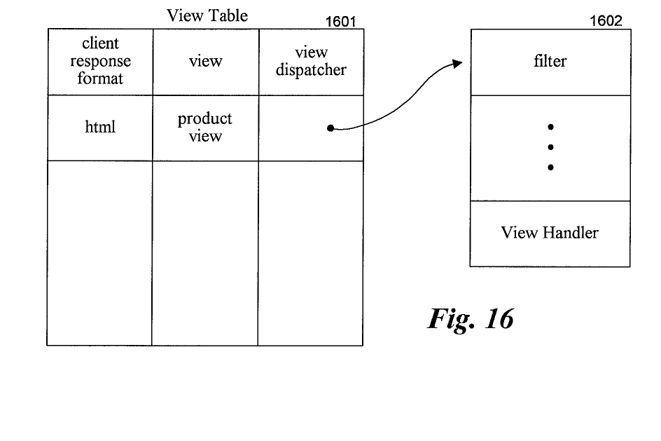

FIG. 16 is a block diagram illustrating the layout of the view table of the application framework. The application framework generates the view table based on the information contained in the configuration file. The view table 1601 contains an entry for each view that is defined in the configuration file. The entries contain a client response format, a view, and a reference to a dispatcher for invoking the filters in sequence and then the view handler as indicated by the view component table 1602. For example, the first entry of the view table indicates that the client response format is “html” and the view is “product-view.”

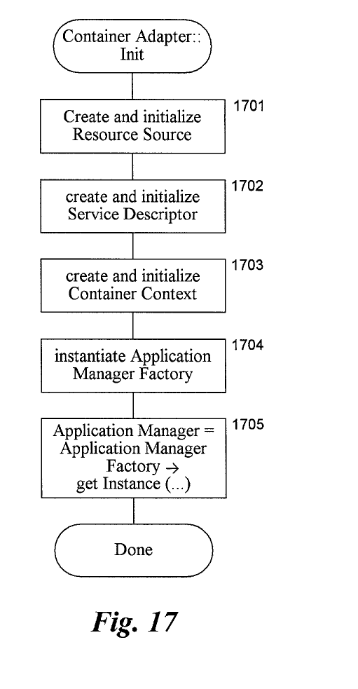

FIG. 17 is a flow diagram illustrating the initialization of an application program by the container adapter. The container adapter provides an initialize method that initializes the application program in accordance with configuration files and initialization parameters. The initialize method is invoked when the container adapter is instantiated. In block 1701, the method creates and initializes a resource source object that defines the configuration information for the application program. In block 1702, the method creates and initializes service descriptor objects that describe the various services that are provided to the application program. In block 1703, the component creates and initializes a container context object that specifies container information that may be needed by the application program. In block 1704, the method instantiates an application manager factory object for creating an instance of an application manager object. An application manager object corresponds to the application framework. In block 1705, the method invokes the get instance method of the application manager factory object passing a class loader, the resource source object, the service descriptor objects, and the container context object. The get instance method returns a reference to the application manager object after loading the application program in accordance with the configuration files. The method then completes.

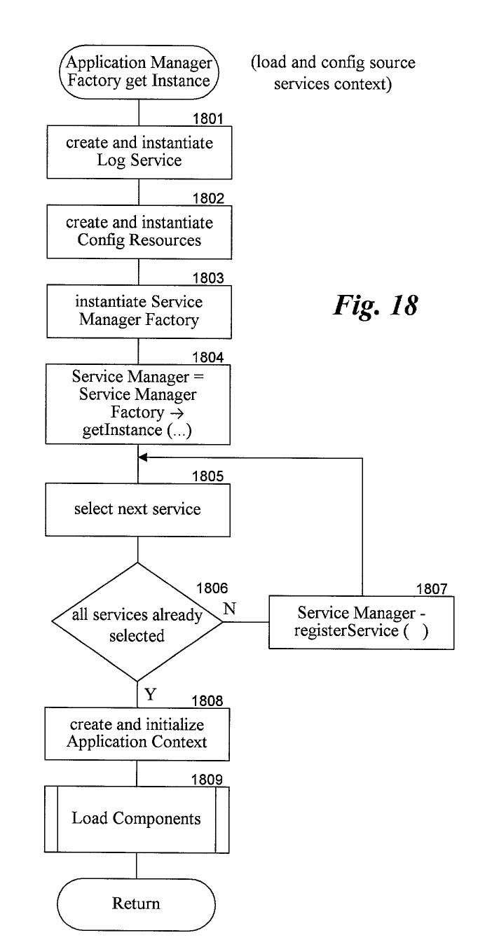

FIG. 18 is a flow diagram of the get instance method of the application manager factory object. This method is passed a class loader, a resource source object, service descriptor objects, and a container context object. In blocks 1801-1802, the method creates and initializes standard service objects that are provided by the application architecture. In this example, the method creates a log service object and a configuration resource service object. In blocks 1803-1807, the method loops registering each service specified in the service descriptor objects. In block 1803, the method creates and initializes a service manager factory object. In block 1804, the method invokes the get instance method of the service manager factory object to retrieve a reference to a service manager object. In block 1805, the method selects at the next service description object. In decision block 1806, if all the service descriptor objects have already been selected, then the method continues at block 1808, else the method continues at block 1807. In block 1807, the method registers the service of selected service descriptor object with the service manager object and then loops to block 1805 to select the next service descriptor object. In block 1808, the method creates and initializes an application context object. In block 1808, the method controls the loading of the various components of the application as specified by the configuration files by invoking the load components function.

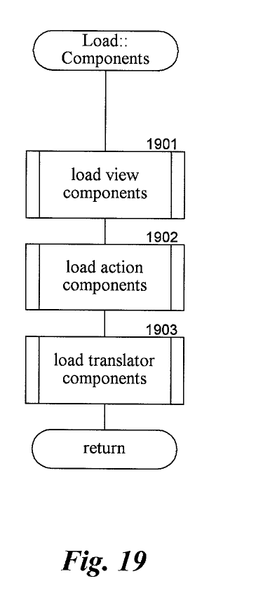

FIG. 19 is a flow diagram of the processing of the load components function. This function loads the view components, the action components, and the translation components of the application program in accordance with the configuration files. In block 1901, the component invokes a load view components function to load the view components. In block 1902, the function invokes a load action components function to load the action components. In block 1903, the function invokes the load translation components function to load the translation components and then returns.

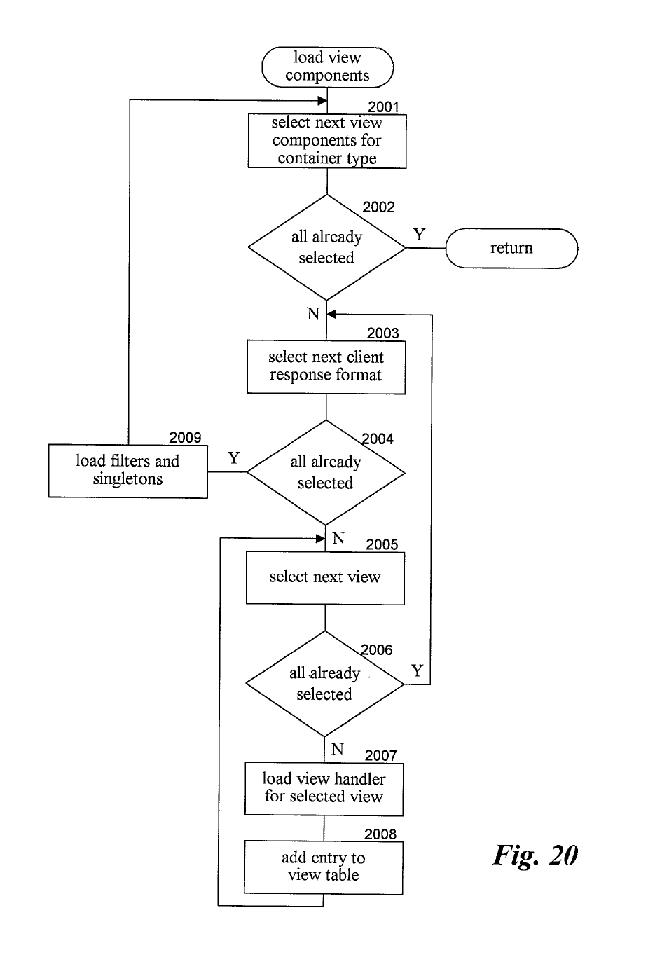

FIG. 20 is a flow diagram of the processing of the load view components function. The function retrieves the view component information from the configuration file, instantiates the view handlers, updates the view table, and instantiates the view filters and singletons for the view layer. In block 2001, the function selects the next view component for a container type from the configuration file. In decision block 2002, if all the view components have already been selected, then the function returns, else the function continues at block 2003. In block 2003, the component selects the next client response format for the selected view component. In decision block 2004, if all the client response formats have already been selected, then the function continues at block 2009, else the function continues at block 2005. In block 2005, the function selects the next view of the selected client response format. In decision block 2006, if all the views have already been selected, then the function loops to block 2003 to select the next client response format for the selected view component, else the function continues at block 2007. In block 2007, the function loads the view handler of the selected view. In block 2008, the function adds an entry to the view table that maps the selected client response format and the selected view to the loaded view handler. The function then loops to block 2005 to select the next view. In block 2009, the function loads the filters and singletons specified in the configuration file for the selected view component. The function then loops to block 2001 to select the next view component.

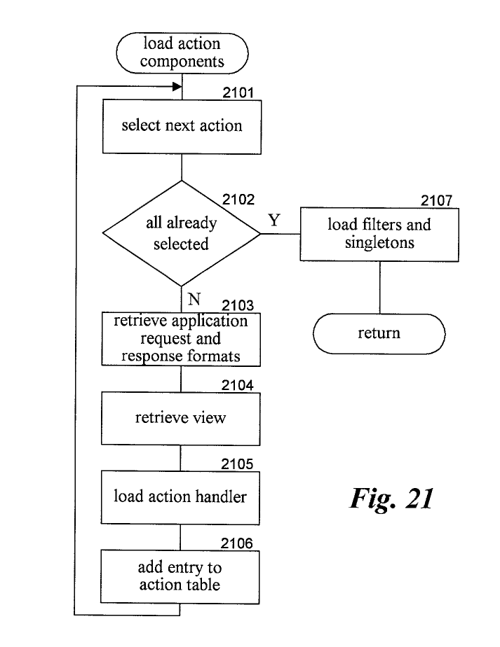

FIG. 21 is a flow diagram of the processing of the load action components function. This function retrieves the action component information from the configuration file, loads the action handlers, updates the action table, and loads the filters and singletons for the action layer. In blocks 2101-2106, the function loops loading each action handler. In block 2101, the function selects the next action from the configuration file. In decision block 2102, if all the actions already selected, then the function continues at block 2107, else the function continues at block 2103. In block 2103, the function retrieves the application request and response formats for the selected action. In block 2104, the function retrieves the view of the selected action. In block 2106, the function loads the action handler of the selected action. In block 2106, the function adds an entry to the action table and loops to block 2101 to select the next action. In block 2107, the function loads the filters and singletons for the action layer and then returns.

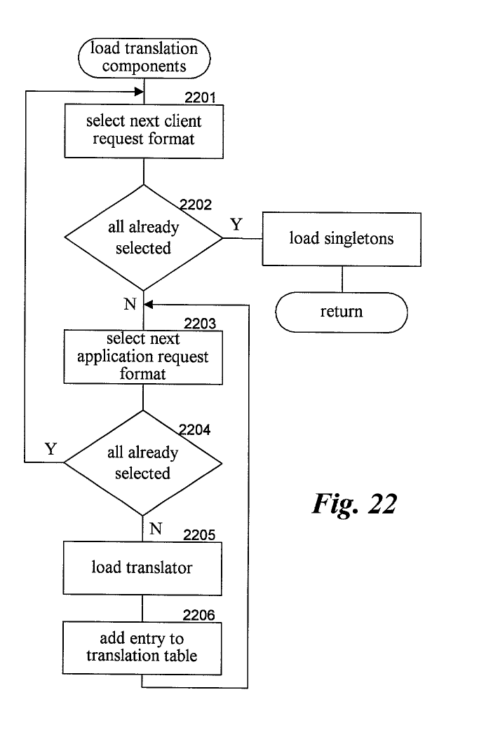

FIG. 22 is a flow diagram of the processing of the load translation components function. This function retrieves the translator components information from the configuration file, loads the translators, updates the translation table, and loads the singletons for the translation layer. In block 2201, the component selects the next client request format. In decision block 2202, if all the client request formats have already been selected, then the function returns, else the function continues at block 2203. In block 2203, the function selects the next application request format for the selected client request format. In decision block 2204, if all the application request formats have already been selected, then the function loops to block 2201 to select the next client request format. In block 2205, the function loads the translator for the selected application request format and the selected client request format. In the block 2206, the function adds an entry to the translation table that maps the translator to translate the selected client request format to the selected application request format and loops to block 2203 to select the next client request format.

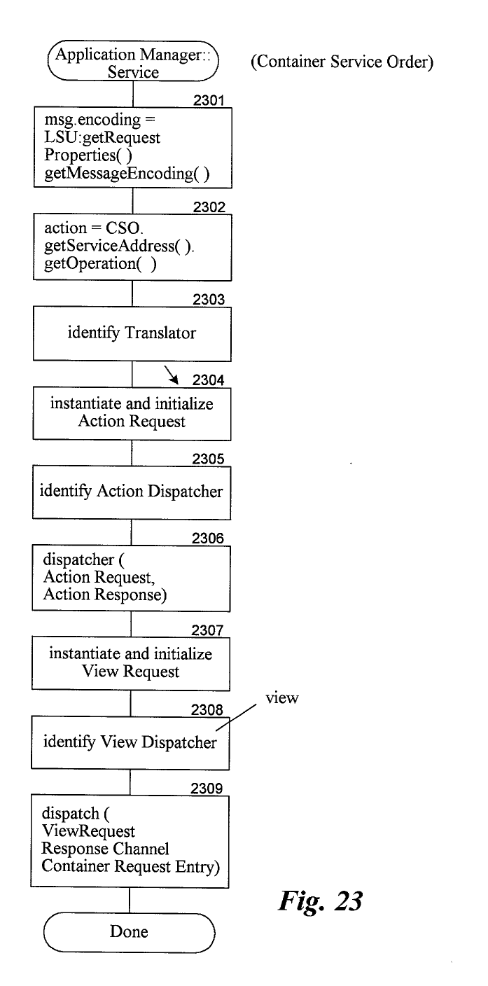

FIG. 23 is a flow diagram of the processing of the service method of an application service manager object. This method is invoked by the container adapter to provide an action request to an application program. The method is passed a container service order object that encapsulates an action request object. In block 2301, the method retrieves the client request format from the service order object. In block 2302, the function retrieves the action name from the client service order object. In block 2303, the method identifies a translator by retrieving the application request format for the action from the action table and then using the client request format and the application request format to identify the translator from the translation table. In block 2304, the method instantiates an action request object and an action response object. The method stores a reference to the identified translator in the action request object. In block 2305, the component identifies the action dispatcher from the action table. In block 2306, the method invokes the dispatch method of the action dispatcher passing an action request object and action response object. In block 2307, the method instantiates a view request object and stores an indication of the client response format and the view returned by the action handler. In block 2308, the method identifies the view dispatcher from the view table using the client response format and the view. In block 2309, the method invokes the dispatcher passing the view request object, response channel object, and container request context object. The method then completes.

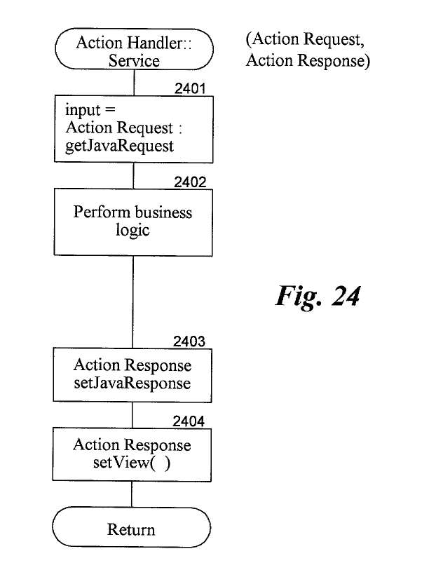

FIG. 24 is a flow diagram illustrating the processing of the service method of an action handler. This method is passed an action request object and action response object. In block 2401, the method retrieves the request message by invoking a function of the action request object. In block 2402, the method performs the business logic associated with the action. In block 2403, the method sets in the response in the action response object. In block 2404, the method sets the view in the action response object and then returns.

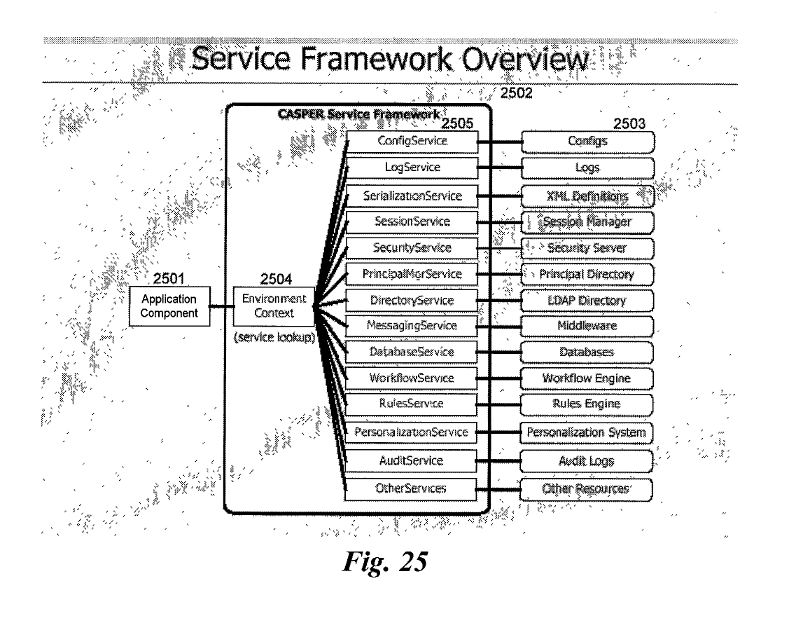

FIG. 25 is a block diagram illustrating the architecture of the service framework in one embodiment. An application component 2501, such as an action handler, uses the service framework 2502 to access various underlying services 2503. The service framework provides a generic mechanism for accessing services that are provided to an of application program. When an application program is loaded, the services as a defined by a services configuration file are also loaded. The application program is provided with a reference to an environment context object 2504 through which the application program can access the various services. To access a service, the application program invokes a lookup method of the environment context object passing the name of the service. The lookup method retrieves a reference to the interface for that service and returns it to the application component. The application component can then invokes the methods on the interface of that service to effect the performance of services. The interfaces provided by the services are published to the developers of the application programs.

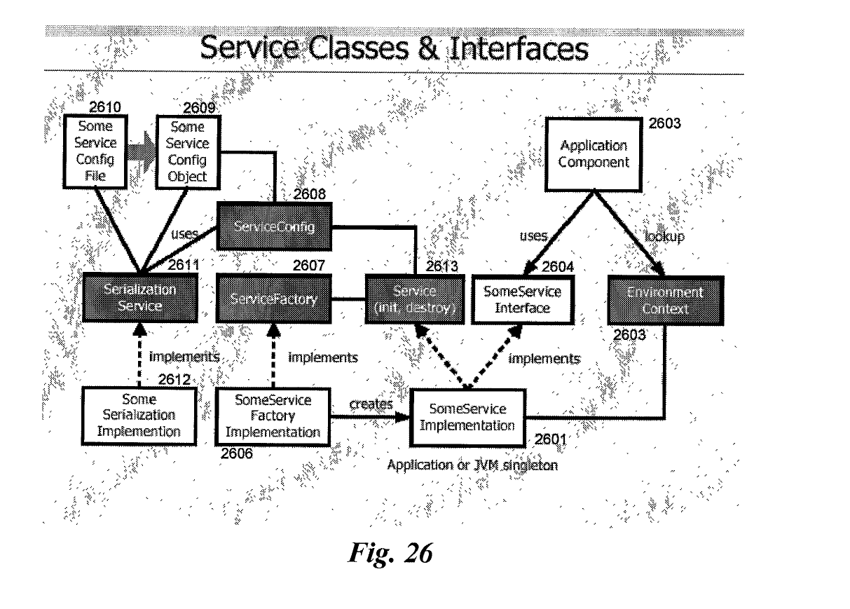

FIG. 26 is a block diagram illustrating the architecture of the service framework. A service implementation 2601 is specified by a configuration file 2610. An application program 2602 invokes the services of application 2601 by first invoking the lookup method of the environment context object 2603. The environment context object returns an interface 2604 to the service. The service implementation is instantiated at load time of the application program under control of the application manager. The configuration file specifies a service factory class that is used it to instantiate a service factory object 2606, which implements a service factory interface 2607. The application manager creates a service configuration object 2608 through which the service can retrieve its configuration information. The service configuration object may use at the services of the serialization service 2611 (described below) to retrieve the configuration information. The application manager then invokes an initialize method of a service interface 2613 provided by the service implementation 2601 passing the service configuration object.

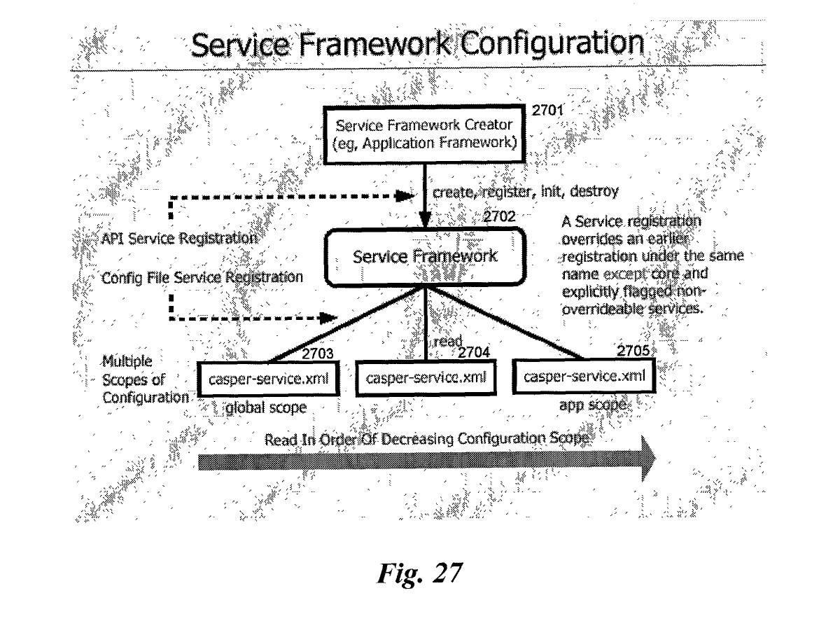

FIG. 27 is a block diagram illustrating the configuring of the service framework. The application manager creates the service framework 2701 by instantiating a service manager factory object that controls the registration of services that are defined in configuration files. The configuration files may represent a hierarchy of a configuration information in which the first processed configuration file represents the broadest scope of configuration information and the last configuration file processed represents the narrowest scope of configuration information. In one embodiment, a service defined in a narrower scope configuration file overrides the service defined in a broader scope configuration file.

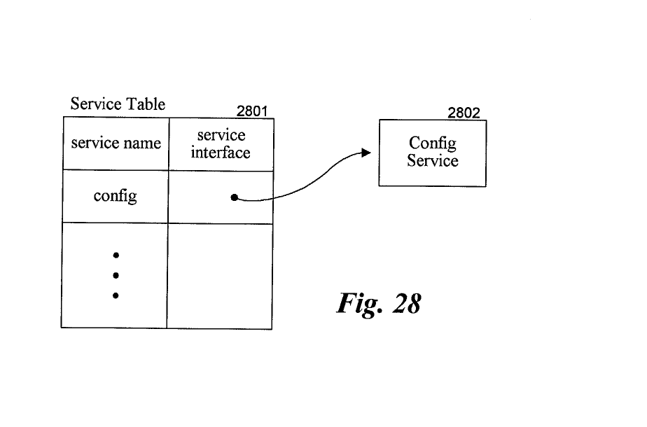

FIG. 28 is a block diagram illustrating a service table in one embodiment. The service table is generated when services are initialized and contains a mapping from the name of services to the interfaces provided by the services. The service table 2801, which is maintained by the service framework, contains an entry for each service that has been defined (i.e., initialized). The entries include the name of the service along with a reference to the service interface provided by that service. As indicated by the first entry in the service table, the name of the service is “config,” and the service interface points to the configuration service 2802.

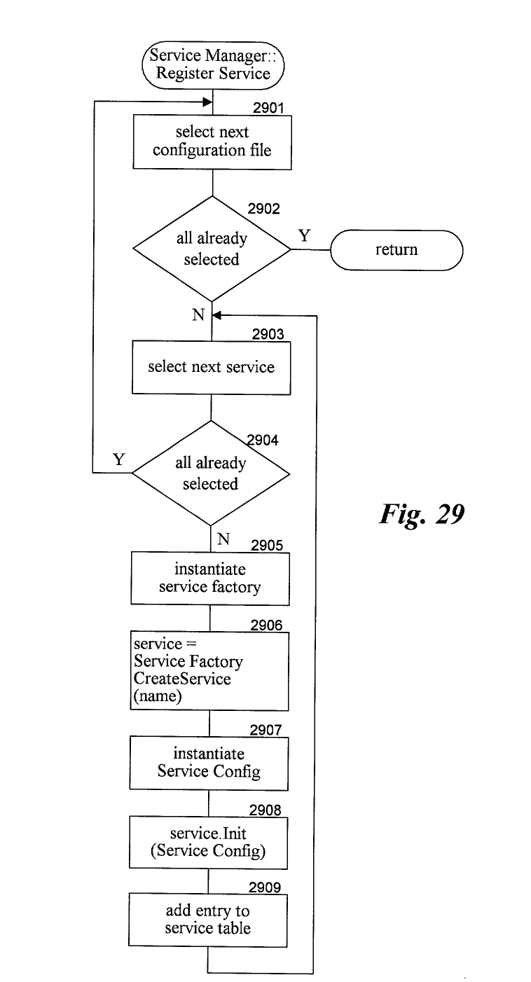

FIG. 29 is a flow diagram illustrating the processing of the register service method of the service manager object in one embodiment. The application manager instantiates a service manager factory object, which in turn provides a reference to a service management object. The service management object provides methods for registering services with the service framework. The register service method is used to register services that are defined in the various configuration files. In block 2901, the method retrieves the next configuration file. In decision block 2902, if all the configuration files have already been selected, then the method returns, else the method continues at block 2903. In blocks 2903-2909, the method loops selecting and registering the services defmed in the selected configuration file. In block 2903, the method selects the next service of the selected configuration file. In decision block 2904, if all the services of the selected configuration file have already been selected, then the method loops to block 2901 to select the next configuration file, else the method continues to block 2905. In block 2905, the method instantiates a service factory object for the selected service as indicated by the selected configuration file. In block 2906, the method invokes the create service method of the service factory object and receives a reference to a service object in return. In block 2907, the method instantiates a service configuration object. In block 2908, the method invokes the initialize method of the service object passing the service configuration object. In block 2909, the method adds an entry to the service table for the selected service and then loops to block 2903 to select the next service for the selected configuration file.

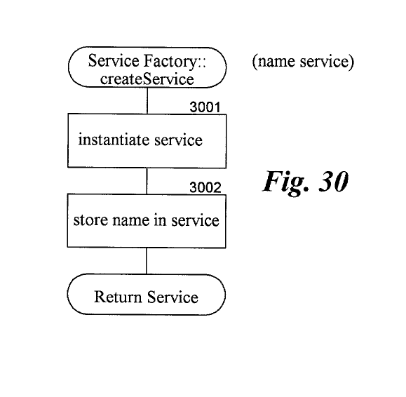

FIG. 30 is a flow diagram illustrating the processing of the create service method in one embodiment. The function is passed the name of the service and returns a reference to the service object. In block 3001, the method instantiates the service. In block 3002, the method stores the passed name in the service object and then returns a reference to the service object.

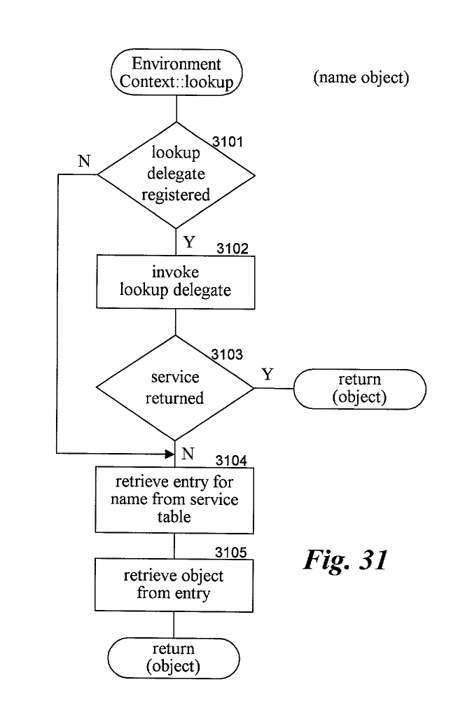

FIG. 31 is a flow diagram of the lookup method of the environment context object. This method is passed the name of a service, identifies the object (interface) associated with that service from the service table, and returns a reference to the service object that implements that service. In block 3101, if a lookup delegate object has been registered for the service, then the method continues at block 3102, else the method continues at block 3104. The service framework allows an application program to register a delegate lookup object. If registered, the service framework delegates the lookup of the service object to that object. In this way, an application program can effectively override previously defined services. In block 3102, the function invokes the lookup method of the delegate object to determine whether a service of the passed name is provided by the delegate object. In decision block 3103, if a service is returned by the delegate object, then the method returns, else no overriding service of that name was found by the delegate object and the method continues at block 3104. In block 3104, the method retrieves the entry for the passed name from the service table. In block 3105, the method retrieves the service object from the retrieved entry and returns the service object.

The serialization service in one embodiment provides a generic mechanism for converting XML data into a Java object and vice versa. As described in more detail in the “schema compiler” patent application, a schema compiler inputs XML data type definitions and automatically generates serialization/deserialization code and validation code for that XML data type definitions. The deserialization code converts the XML data into a Java object, and the serialization code converts a Java object into XML data. The serialization service may be invoked by the application components (e.g., action handlers and translators) to convert XML data to a Java object and vice versa. When the serialization service is configured, it is provided with a mapping of XML data type definitions to Java class definitions for serialization, deserialization, and validation that are tailored to the application program that is being loaded. When the application program invokes a method of an action request object to retrieve the request message, the translator is invoked. The translator may use the serialization service to serialize and deserialize the request message as appropriate. In addition, the translator may use the validation code to validate the XML data.

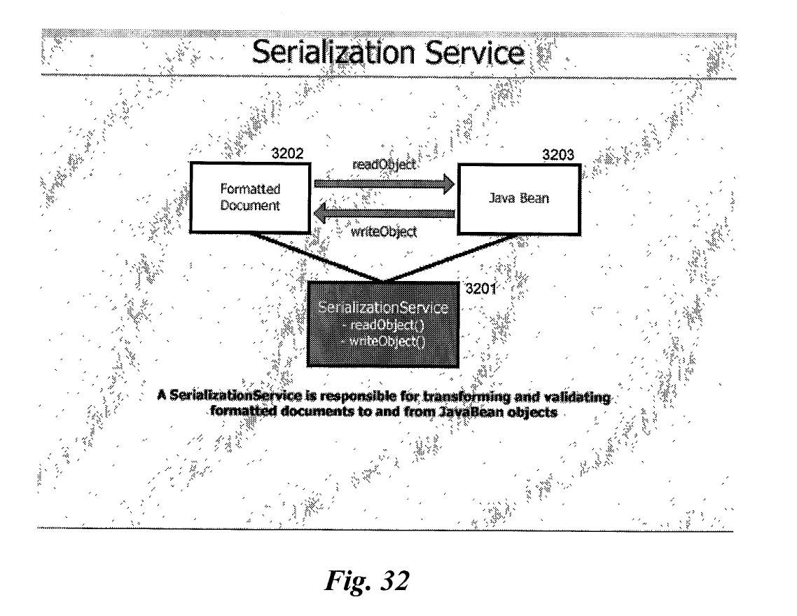

FIG. 32 is a block diagram illustrating invocation of the serialization service. The serialization service 3201 provides a read object method for deserializing and XML formatted document 3202 and a write object method for serializing a Java object 3203. The read object and write object methods may be invoked by a translator or other application program component, such as an action handler during its initialization.

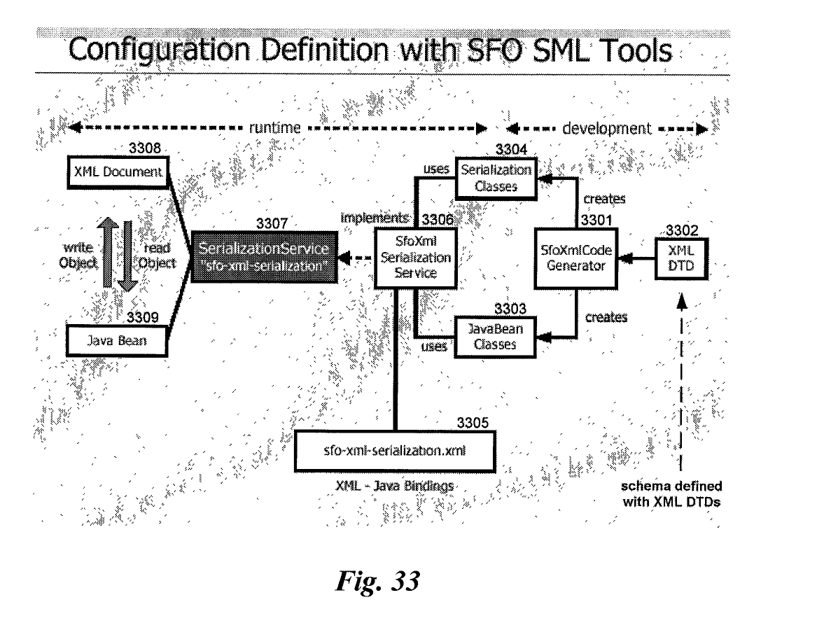

FIG. 33 is a block diagram illustrating the architecture of the serialization service in one embodiment. When an application program is a being developed, XML data type definitions 3302 are generated for the messages and for the configuration files to be used by the application program. The XML code generator 3301 inputs the XML data type definitions and outputs class definitions 3303 for the Java objects and outputs serialization classes 3304. The serialization classes are used to serialize, deserialize, and validate the XML data. At runtime, the serialization service 3306 uses the Java object classes and deserialization classes to provide the serialization interface 3307.

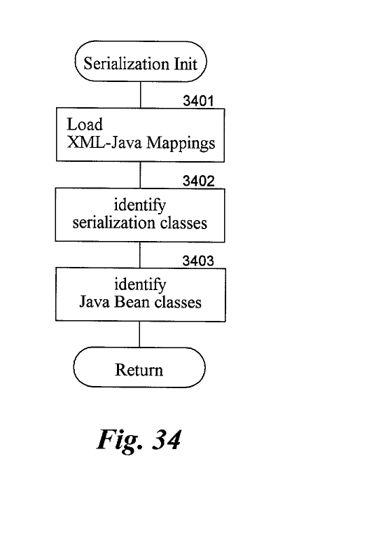

FIG. 34 is a flow diagram illustrating the initialize method of the serialization service in one embodiment. The method loads the XML to Java mappings, identifies the serialization classes, and identifies the Java object classes from various configuration files. In block 3401, the method loads the XML to Java mappings, which map various XML formats to Java object classes. In block 3402, the function identifies the serialization classes. In block 3403, the function identifies the Java object classes and then returns.

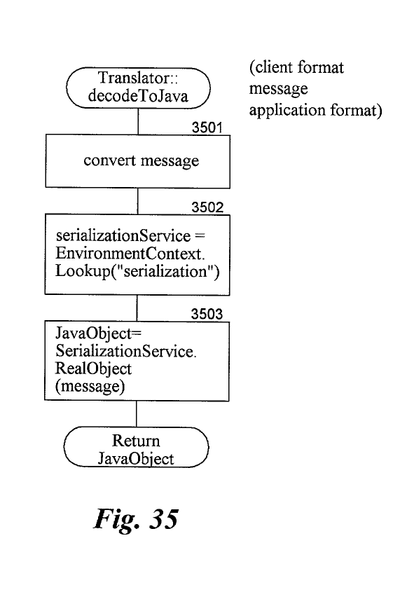

FIG. 35 is a flow diagram illustrating the processing of the decode to Java method of a translator in one embodiment. This method is passed an indication of the client format, the message to be translated, and the application format. The method deserializes the message and returns the Java object representing the message. In block 3401, the method performs any processing necessary to convert the message from the client format to the application format. In block 3502, the method retrieves a reference to the serialization service by invoking the lookup method of the environment context object. In block 3503, the method invokes the read object method of the serialization service passing the message to be deserialized into a Java object. The method then returns the Java object.

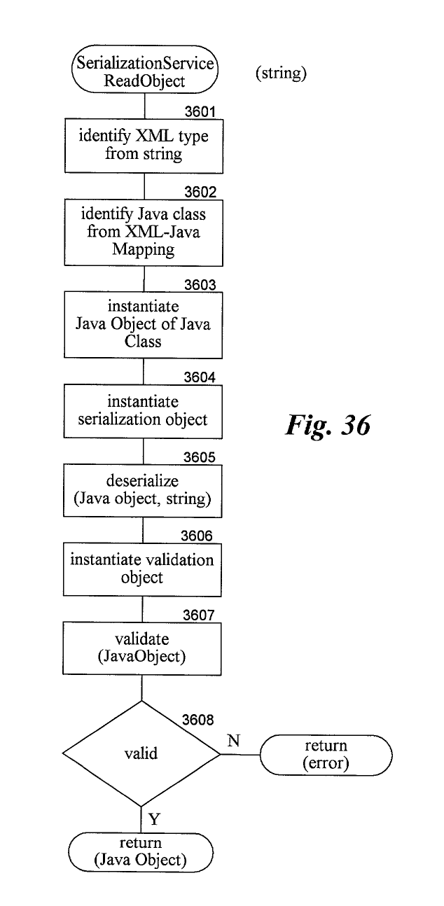

FIG. 36 is a flow diagram illustrating the processing of the read object method of the serialization service in one embodiment. The read object method is passed a string containing the XML data and returns a Java object. In block 3601, the method identifies the XML type from the string. In block 3602, the method identifies the Java class for the Java object to be returned and identifies a class for performing the serialization and validation associated with the identified Java class. In block 3603, the method instantiates the Java object of the identified Java class. In block 3604, the method instantiates a serialization object. In block 3605, the method invokes the deserialize method of the serialization object passing the reference to the Java object. In block 3606, the method instantiates a validation object. In block 3607, the method invokes the validate method of the validation object passing the Java object. In decision block 3608, if the data of the Java object is valid, then the method returns the Java object, else the method returns an error.

The application architecture also provides a configuration service to facilitate the configuring of application components. In one embodiment, the configuration service allows an application program to be configured in accordance with multiple layers of configuration information. Each layer of configuration information represents a decreasing scope. For example, the first layer of configuration information may represent global information that is applicable to all application programs that use the application architecture. The second layer of configuration information may represent information that is applicable to only those application programs that operate in a web environment. The third layer of configuration information may represent information that is applicable to only to a certain application program. The configuration information may be stored in configuration files in various directories known to the configuration service through its own configuration information. The configuration service returns an interator through which an application program can successively retrieve the configuration information of decreasing scope.

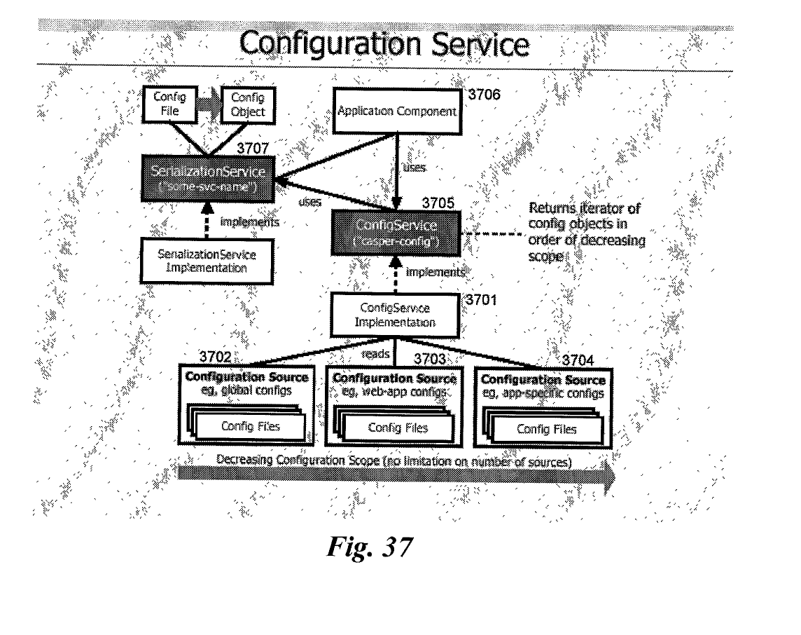

FIG. 37 is a block diagram illustrating the architecture of the configuration service in one embodiment. The configuration service implementation 3701 accesses various configuration sources 3702, 3703, and 3704 of decreasing scope. An application component 3706 uses the configuration service interface 3705 to retrieve the iterator for the configuration information. The configuration service may itself use the serialization service 3707 to retrieve the configuration information. In particular, each of the configuration files may be an XML document that is known to the serialization service. When requested by the configuration service, the serialization service deserializes the configuration file into a Java object that is used by the application components.

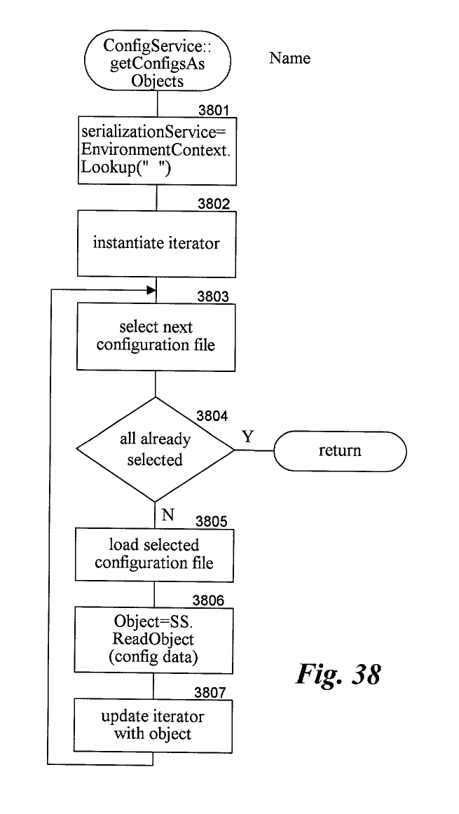

FIG. 38 is a flow diagram illustrating a get configuration as objects method of the configuration service in one embodiment. This method is passed the name of the configuration files to retrieve and returns an interator for retrieving the Java objects representing the configuration files. In block 3801, the method invokes the lookup method of the environment context object to retrieve the reference to the serialization service. In block 3802, the method instantiates an iterator through which the Java objects corresponding to the deserialized configuration information can be retrieved. In blocks 3803-3807, the method loops selecting each configuration file and deserializing it. In block 3803, the method selects the next configuration file starting with the configuration file with the broadest scope. In decision block 3804, if all the configuration files have already been selected, then the method returns the iterator, else the method continues at block 3805. In block 3805, the method loads the selected configuration file. In block 3806, the method invokes the read object method of the serialization service passing the configuration information of the selected configuration file. The read object method returns the deserialized Java object. In block 3807, the method updates the iterator to include the deserialized Java object and then the loops to block 3803 to select the next configuration file.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A computer system having an application architecture comprising:
a plurality of action handlers, each action handler for servicing a request for service in an application request format and for generating a response in an application response format and a view;
a plurality of translators, each translator for translating a request for service into an application request format;
a plurality of view handlers, each view handler for preparing a response in accordance with the generated responses and views of the action handler; and
an application framework that upon receiving a request for service, identifies a translator for translating the request into the application request format, identifies an action handler for servicing the request, invokes the identified action handler passing the request and an indication of the identified translator, receives a response in the application response format and a view fro the actio handler, identifies a view handler for processing the received response and view, and invokes the identified view handler passing the response and view to generate a response to the received request.

2. The computer system of claim 1 wherein the application framework loads applications having action handlers, view handlers, and translators.

3. The computer system of claim 2 wherein the applications are loaded based on configuration information.

4. The computer system of claim 1 wherein the application framework passes to the identified view handler information for sending the generated response to a client computer.

5. The computer system of claim 1 wherein the received request is in a client request format and the identified translator translates from the client request format to the application request format.

6. The computer system of claim 1 including:
a plurality of service components for providing services to an action handler, a view handler, or a translator, and
a service framework that receives a request to access a service component with a certain name, identifies the service component with that name, and returns a reference to that service component.

7. A computer system having an application architecture comprising:
a plurality of action handlers, each action handler for servicing a request for service in a application request format and for generating a response in an application response format and a view;
a plurality of view handlers, each view handler for preparing a response in accordance with the generated responses and views of the action handler; and
an application framework that upon receiving a request for service, identifies an action handler for servicing the request invokes the identified action handler passing the request, receives a response in the application response format and a view from the action handler, identifies a view handler for processing the received response and view, and invokes the identified view handler passing the response and view to generate a response to the received request.

8. The computer system of claim 7 wherein the application framework loads applications having action handlers and view handlers.

9. The computer system of claim 8 wherein the applications are loaded based on configuration information.

10. The computer system of claim 7 wherein the application framework passes to the identified view handler information for sending the generated response to a client computer.

11. The computer system of claim 7 wherein the received request is in a client request format and a translator translates from the client request format to the application request format.

12. The computer system of claim 7 including:
a plurality of service components for providing services to an action handler, a view handler, or a translator; and
a service framework that receives a request to access a service component with a certain name, identifies the service component with that name, and returns a reference to that service component.

13. The computer system of claim 7 including:
a container adapter for providing an interface between the application framework and a container, wherein the provided interface is independent of the container.

14. The computer system of claim 13 including:
a plurality of service components for providing services to an action handler, a view handler, or a translator; and
a service framework that receives a request to access a service component with a certain name, identifies the service component with that name, and returns a reference to that service component.

15. The computer system of claim 7 including:
an action filter that is associated with an action handler whereby the action filter is invoked prior to invoking the associated action handler.

16. The computer system of claim 15 wherein the action filter is associated with the action handler based on information in a configuration file.

17. A computer-readable medium containing instructions for causing a computer system to perform functionality of an application, comprising:
a translator layer having translators, each translator for translating data in one format to another format;
an action layer having action handlers, each action handler for receiving a request for performing business logic, for using a translator for converting the request into a format suitable for performing the business logic, for performing the business logic, and for generating a response, and identifying a view for presenting the response; and
a view layer having view handlers, each view handler for receiving a response generated by an action handler, for receiving a view for presenting the response, and for generate a response to provide to a client computer based on the received response and view.

18. The computer-readable medium of claim 17 including:
an application framework that upon receiving a request for service, identifies an action handler for servicing the request, identifies a translator for translating the request into a format suitable for processing by the identified action handler, invokes the identified action handler passing an indication of the identified translator and request, receives a response and a view from the action handler, identifies a view handler for processing the received response and view, and invokes the identified view handler passing the response and view to generate a response to the received request.

19. The computer-readable medium of claim 18 wherein the application framework loads the action handlers, view handlers, and translators.

20. The computer-readable medium of claim 19 wherein the loading is in accordance with configuration information.

21. The computer-readable medium of claim 18 wherein an action handler has an action filter that is invoked prior to invoking the action handler.

22. The computer-readable medium of claim 21 wherein the action filter is passed the same information as is passed to the action handler.

23. A computer-readable medium containing instructions for causing a computer system to control execution of application, comprising:
a loader for loading action handlers, view handlers, and translators; and
a request servicing component for receiving requests for service, for identifying action handlers for servicing each request, for identifying translators for translating each request into a format suitable for processing by the identified action handler, for invoking the identified action handler passing an indication of the identified translator and the request, receiving a response and a view from the invoked action handler, for identifying a view handler for processing the received response and view, and for invoking the identified view handler passing the response and view to generate a response to the received request.

24. The computer-readable medium of claim 23 wherein the loader loads based on configuration information.

25. The computer-readable medium of claim 23 including
a container adapter that interfaces with a container and provides a container-independent interface to the request servicing component.

26. The computer-readable medium of claim 23 wherein the container adapter invokes a service function of the servicing request component passing a request.

27. The computer-readable medium of claim 23 including:
a service framework component that loads a plurality of service components during initialization of the service framework component, each service component having a name and an implementation and that receives a name of a loaded service component and returns a reference to an implementation of the service component of the received name.
